(19) United States
(12) Patent Application Publication
(10) Pub. No.: US 2004/0075961 A1
(43) Pub. Date: Apr. 22, 2004

(54) Movable barrier safety control

(75) Inventor: Ira G. DaVall, Rocky Point, NY (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/615,709

(22) Filed: Jul. 9, 2003

Related U.S. Application Data
(60) Provisional application No. 60/396,071, filed on Jul. 16, 2002.

(51) Int. Cl. H02H 3/00

(52) U.S. Cl. 361/1

(57) ABSTRACT

Methods and apparatus for detecting obstructions in the path of a movable barrier are disclosed. Embodiments are included which advantageously combine edge sensing contact detectors and non-contact detectors such as photo eye detectors. Relay logic is also described for controlling the response of a movable barrier operator to input signals including input signals from contact type and non-contact obstruction detectors.

### CROSS REFERENCE TO RELATED APPLICATIONS

This application is a utility patent based on U.S. provisional application Serial No. 60/396,071, filed Jul. 16, 2002, which is incorporated herein by reference in its entirety.

The present invention relates to safety systems for the movement of movable barriers.

Movable barrier control systems such as door, garage door, sliding gate, swinging gate, etc. generally include some form of obstruction detection. Such detection may include contact edges or non-contact sensing such as infra-red (IR) optical devices ultra-sonic, Radio Frequency, etc. to detect the presence of an obstruction in the path of the barrier and control the movement of the barrier based on such a detected obstruction. A need exists for improved arrangements for obstruction sensing and resultant barrier movement.

### BRIEF DESCRIPTION OF THE DRAWING

FIG. 1 represents the basic safety and control structure of an automatic sliding gate;

FIG. 2 is a block diagram of a combined IR and physical contact obstruction detection system for a movable barrier;

FIG. 3 is a block diagram on IR obstruction sensing system.

FIG. 4 is a schematic diagram of relay logic responsive to the contacts of a voltage sensing relay to control barrier movement.

### DESCRIPTION

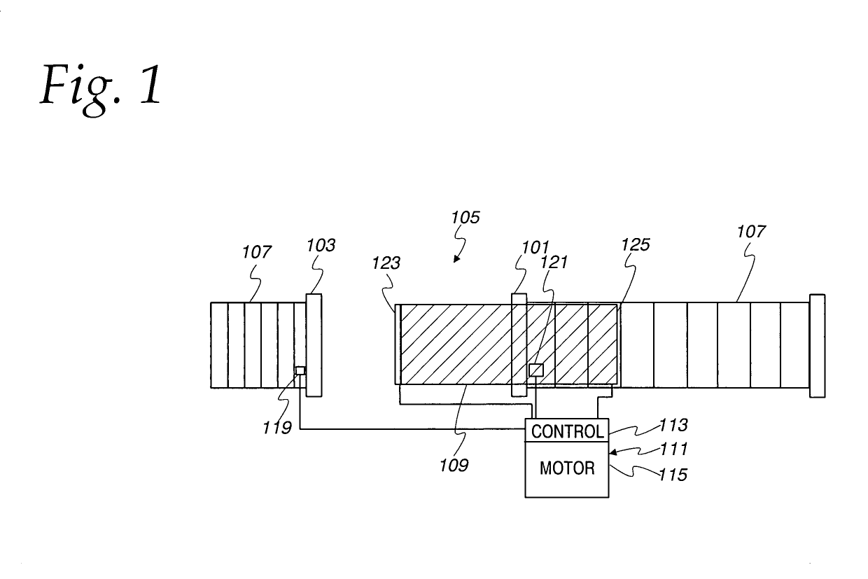

FIG. 1 illustrates an automatic sliding gate arrangement for illustration purposes. The principles taught regarding the operation of the FIG. 1 arrangement are easily applicable to other types of automatic barrier movement arrangements. In FIG. 1 pylons 101 and 103 define a gate opening 105 in a fence 107. A control unit 111 which includes a control circuit 113 and a motor 115 responds to user requests to open and close a gate 109 by sliding it across the gate opening 105. The user requests may arrive in the form of signals from a push button key-pad or as coded rf signals which are received by the control circuit 113, decoded and approved or not, as is well known in the art.

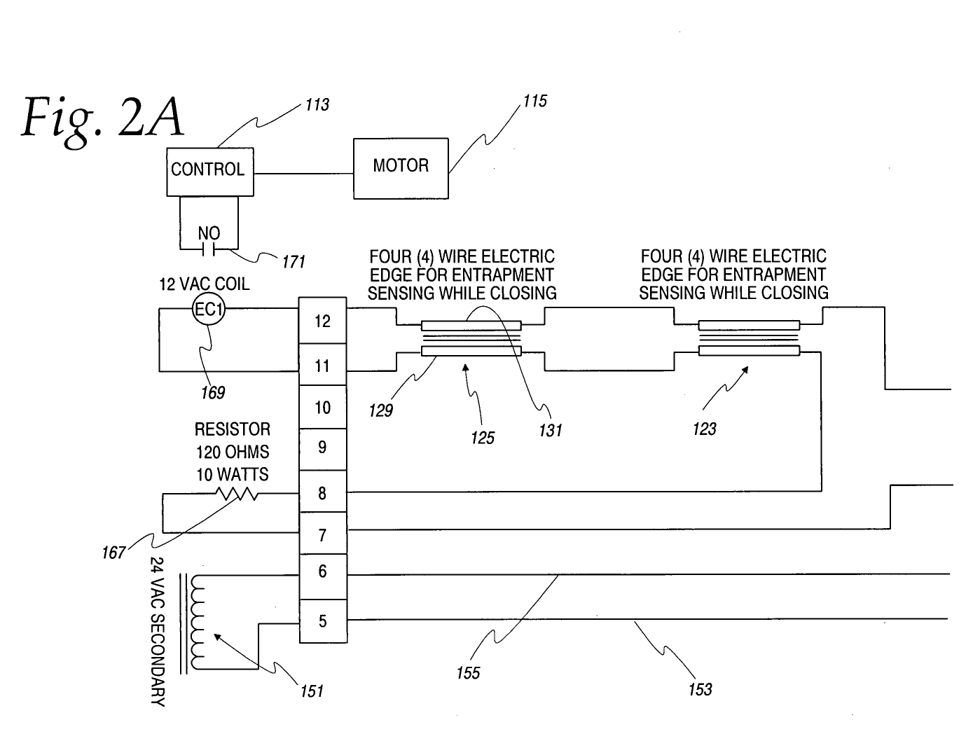

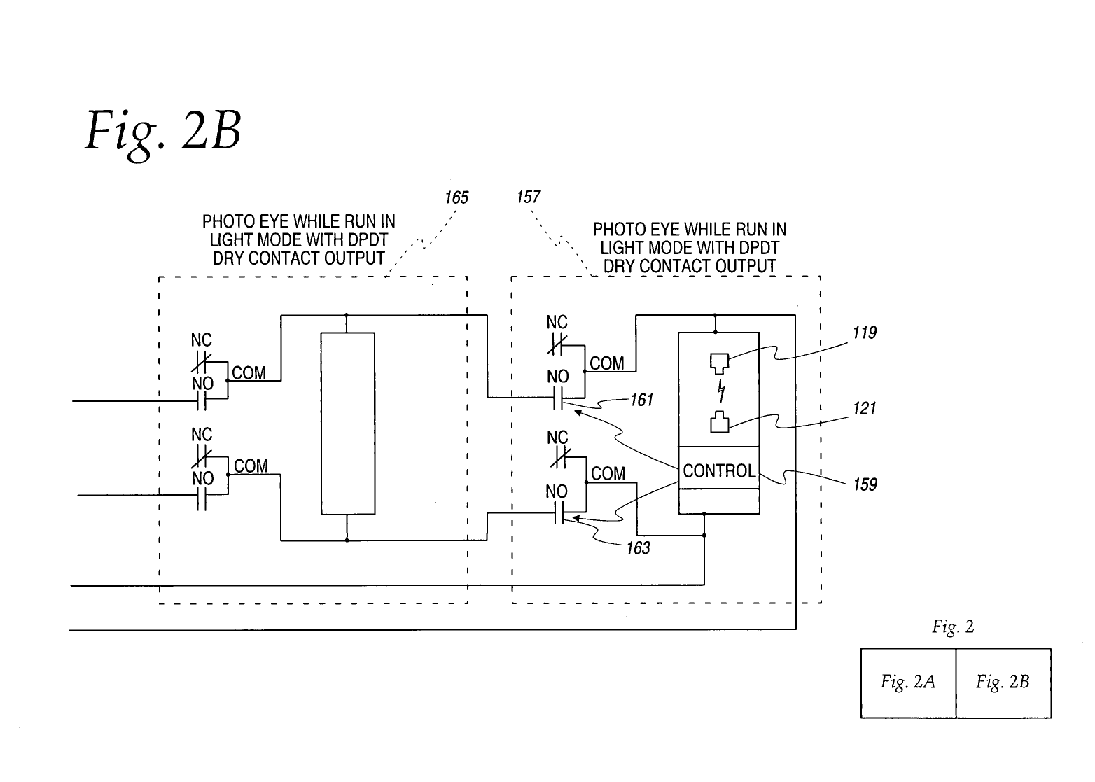

Before a barrier begins to move and during movement it is advantageous to identify whether an obstruction is present which may be contacted by the moving barrier. The arrangement of FIG. 1 includes an IR transmitter 119 and an IR receiver 121. As can be readily seen other types of non-contact sensors such as ultra-sonic, optical etc. may be employed in place of the IR transmitter and receiver. Under the control of control circuit 113 transmitter 119 directs an IR beam to receiver 121 which detects the presence or absence of a received IR beam to identify obstructions in the path of the barrier. The apparatus of FIG. 1 also includes contact type obstruction sensors 123 and 125 which identify when the barrier physically contacts an obstruction during closing (123) or during opening (125). As shown in FIG. 2 the contact obstruction sensors comprise a pair of spaced apart conductors 129 and 131. When the obstruction detector deforms due to contact with an obstruction, the conductors 129 and 131 make contact thereby changing the manner of current flow through the detector. Such a change in current flow indicates, in a manner discussed below, that an obstruction has been contacted.

FIG. 2 is a block diagram of the interaction of control circuit 113 and the sensors 123, 125, 119 and 121 to control barrier movement. Control unit 111 includes a voltage source such as transformer secondary 151 which supplies a voltage of, for example 24 vac, between conductors 153 and 155. Conductors 153 and 155 are connected to an IR obstruction arrangement 157 which represents, in part, IR transmitter 119 and IR receiver 121 and a controller 159. When powered from the voltage source 151 an IR beam is sent and received, as discussed above, and receiver 121 sends a signal to control 159 to indicate reception of such an IR beam or not. When controller 159 is notified that an IR beam is being received, normally open switches 161 and 163 are closed to pass the voltage between conductors 153 and 154 on to subsequent apparatus. Alternatively, when no IR beam is received by receiver 121 switches 161 and 163 are opened to their normal state and no voltage is applied to the conduction path beyond obstruction detector 157. The voltage between conductors 153 and 155 is passed on to an optional IR sensor 165 which operates in the same manner to close or open the voltage path depending on whether an obstruction is sensed. The optional IR detector 165 is not employed in FIG. 1. When other types of non-contact sensors are used they function to close contacts such as 161 and 163 when no obstruction is detected and to open the contacts in the case of system failure or detected obstruction.

The conduction path proceeds beyond detector 165 to the contact edge sensors 123 and 125 via a resistor 167. Resistor 167 is used to control excessive currents when conductors e.g., 129 and 131 contact one another. The conduction path continues through edge detectors 123 and 125 to a voltage sensor 169 which is shown in FIG. 2 as a relay coil EC1. Relay EC1 includes a normally open contact pair 171 the state of which is sensed by control 113. Whenever the contacts 171 are opened control circuit 113 directs motor 115 to move the barrier to a safe position. Such a safe position in the case of an overhead door is the open position. In the case of gate 109 the safe position may be backing off the obstruction, or reversing to maximum travel in the opposite direction that the gate was traveling when the obstruction was sensed. Should an obstruction be sensed while the gate is retreating from a prior obstruction, stopping the gate is considered to be the safe position.

As is apparent from FIGS. 1 and 2 and the preceding description, whenever an obstruction is sensed or a failure occurs along the conduction path from voltage source 151 to sensor 169, control 113 will sense such and control motor 115 to move the barrier 109 to a safe position. Alternatively, as long as voltage sensor 169 continues to sense a predetermined voltage from source 151, control 113 will control the motor to move the barrier 109 in accordance with user or other commands.

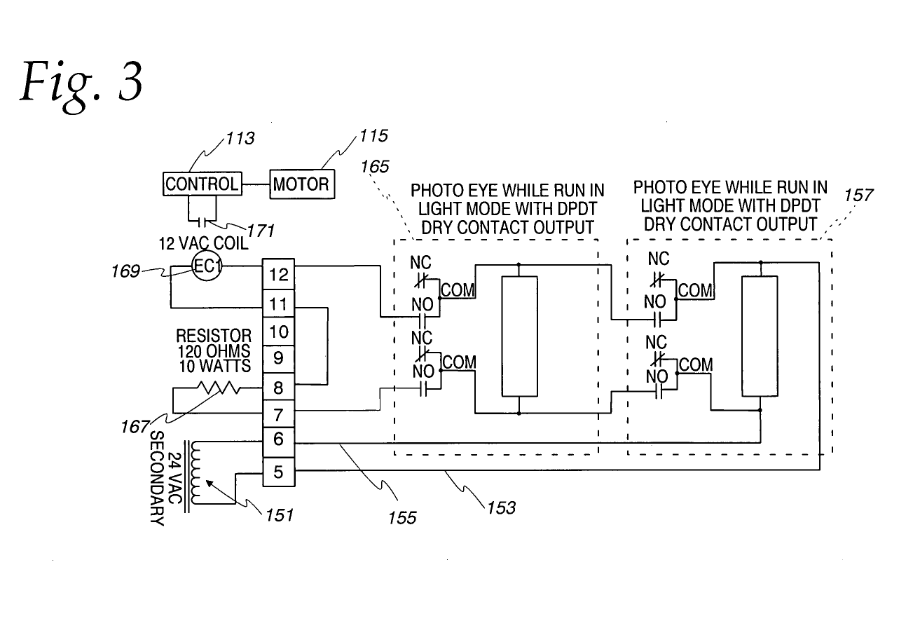

FIG. 3 shows an obstruction sensing arrangement similar to that shown in FIG. 2 except without the contact sensors 123 and 125. The dropping resistor 167 may be removed from the embodiment of FIG. 3, and relay 169 replaced with a 24V relay, because no current carrying parts of FIG. 3 require the protection of such a resistor.

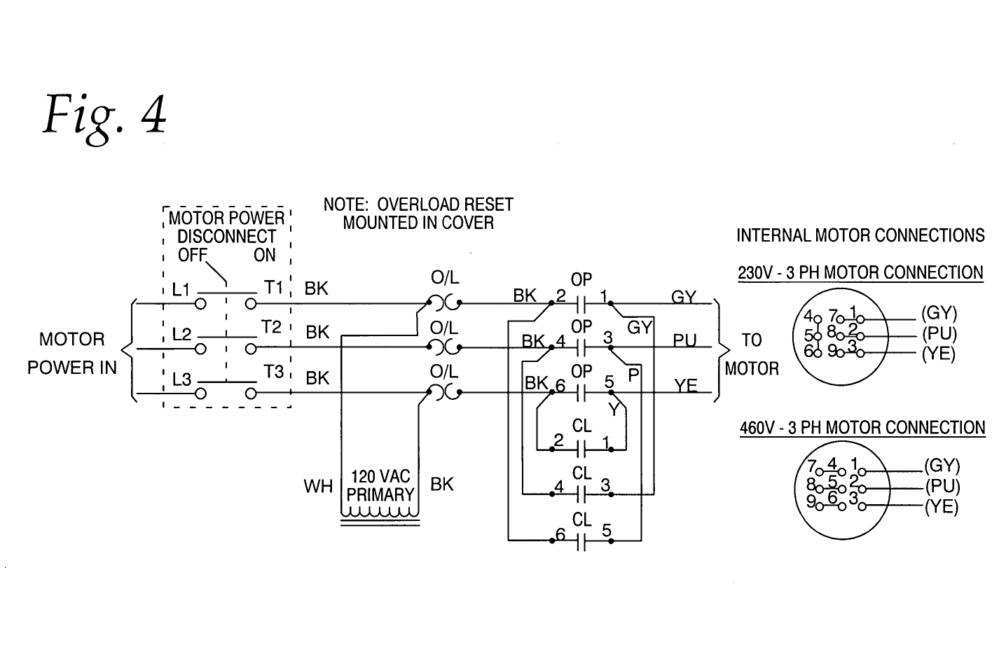

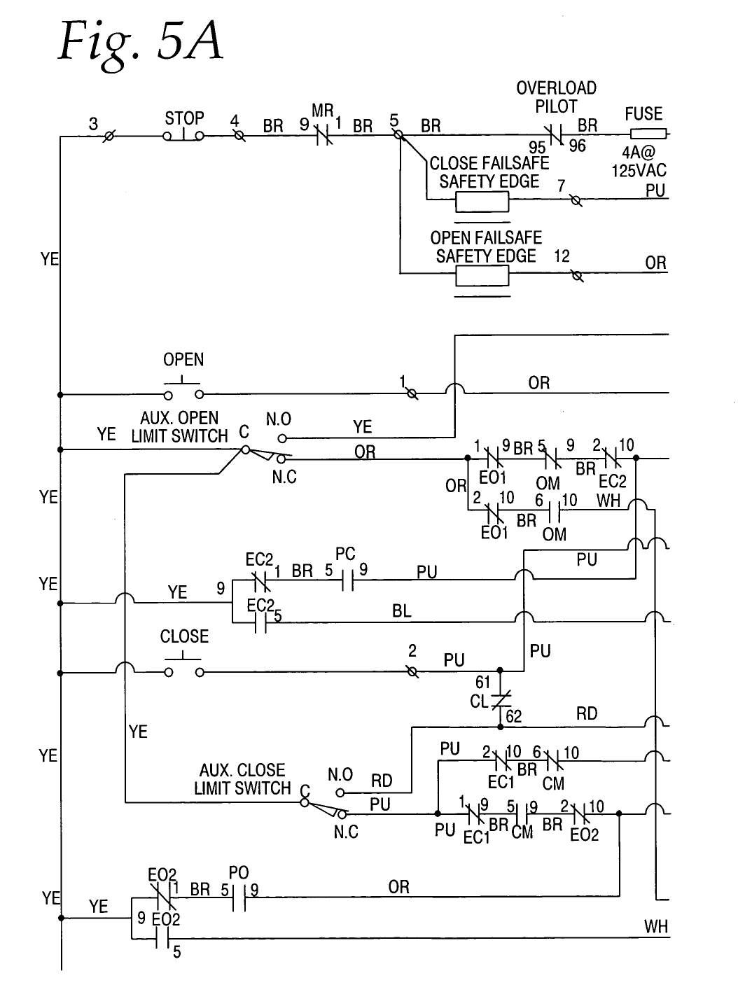

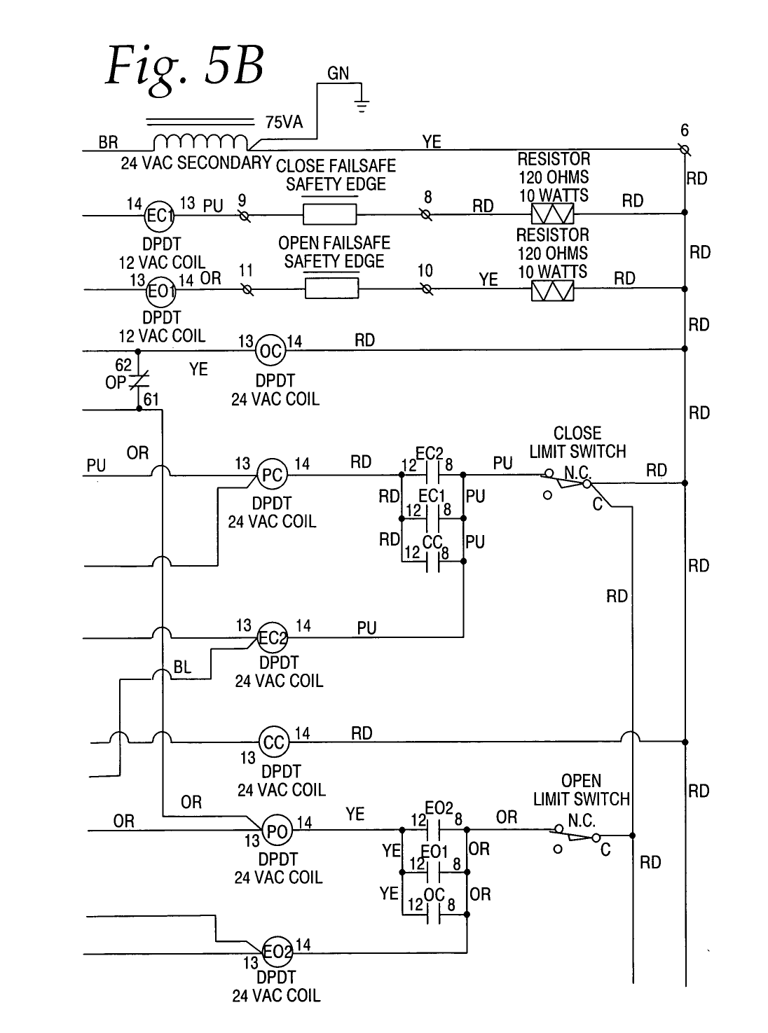

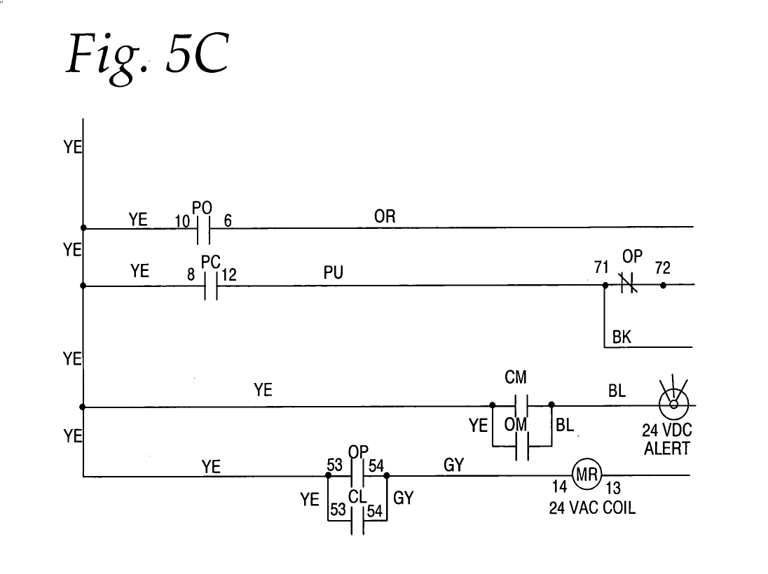

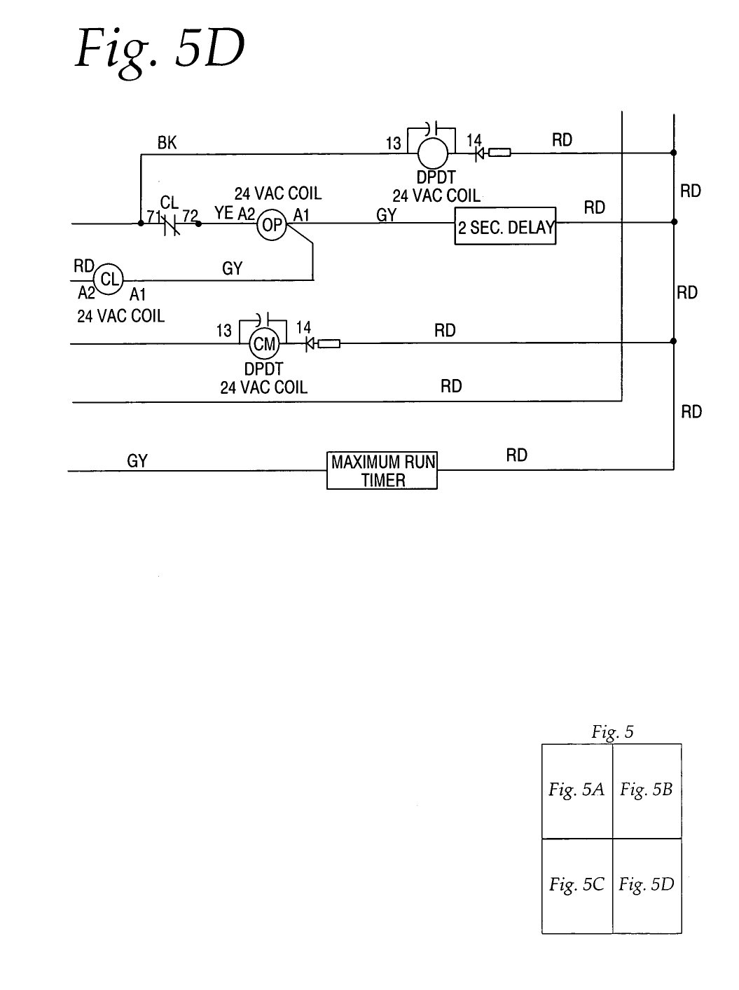

FIG. 4 shows a relay logic controller for use in control circuit 113.

The drawings and the foregoing descriptions are not intended to represent the only forms of the invention in regard to the details of its construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation, the scope of the invention being delineated by the following claims.

1. A safety apparatus for a movable barrier operator comprising:
a source of electrical voltage between a first conductor and a second conductor;
a non-contact obstruction detector connected to the first and second conductors for detecting obstructions to movement of the barrier;
a voltage sensing apparatus connected between a first conduction path and a second conduction path; and
the non-contact obstruction detector comprises switch apparatus for connecting the first and second conductors to the first and second conduction paths.

2. The safety apparatus of claim 1 wherein the non-contact obstruction detector comprises an optical obstruction detector.

3. The safety apparatus of claim 1 wherein the switch apparatus disconnects one or both of the first and second conduction paths from the first and second conductors in response to an obstruction.

4. The safety apparatus of claim 1 wherein the switch apparatus disconnects one or both of the first and second conduction paths from the first and second conductors in response to a fault of the obstruction detector.

5. The safety apparatus of claim 1 wherein one or both of the first and second conduction paths comprises a portion of a barrier edge obstruction detector.

6. The safety apparatus of claim 5 wherein the barrier edge obstruction detector responds to an obstruction contacting the door edge by connecting the first and second conduction paths.

7. The safety apparatus of claim 5 wherein the barrier edge obstruction detector responds to an obstruction contacting the door edge by opening one or both of the first and second conduction paths.

8. The safety apparatus of claim 1 wherein the voltage sensing apparatus comprises a relay having a coil connected to the first and second conduction paths.

9. The safety apparatus of claim 8 wherein the relay comprises a contact pair and the safety apparatus comprises circuitry for sensing a state of the contact pair.

10. The safety apparatus of claim 9 wherein the circuitry for sensing comprises semiconductor circuitry.

11. The safety apparatus of claim 10 wherein the semiconductor circuitry comprises a microprocessor.

12. The safety apparatus of claim 9 wherein the circuitry for sensing comprises relay logic circuitry.

13. The safety apparatus of claim 1 comprising a resistance serially connected in one or both of the conduction paths.

14. The combination of claim 8 comprising a resistance, similar in amount to a resistance of the coil, serially connected in one or both of the first and second conduction paths.

15. In combination:
a motor for moving a barrier between an open and a closed position;
a source of electrical voltage between a first conductor and a second conductor;
a non-contact obstruction detector connected to the first and second conductors for detecting obstructions to movement of the barrier;
a voltage sensing apparatus connected between a first conduction path and a second conduction path;
the non-contact obstruction detector comprises switch apparatus for connecting the first and second conductors to the first and second conduction paths; and
control apparatus for energizing the motor to move the barrier to a safe position when the voltage sensing apparatus senses voltage less than a predetermined value.

16. The combination of claim 15 wherein the safe position is the open position.

17. The combination of claim 15 wherein the safe position is the closed position.

18. The combination of claim 15 wherein the non-contact obstruction detector comprises an optical obstruction detector.

19. The combination of claim 15 wherein the safe position is backing away from the obstruction a predetermined distance.
